(19) United States
(12) Patent Application Publication
(10) Pub. No.: US 2026/0027654 A1
(43) Pub. Date: Jan. 29, 2026

(54) WELDING METHOD AND WELDING STRUCTURE

(71) Applicant: Prime Planet Energy & Solutions, Inc., Tokyo (JP)

(72) Inventors: Katsuaki ISHITANI, Kasai-shi (JP); Tomomi TANAKA, Osaka (JP)

(21) Appl. No.: 19/258,896

(22) Filed: Jul. 3, 2025

(30) Foreign Application Priority Data
Jul. 23, 2024 (JP) 2024-117467

(51) Int. Cl. B23K 26/323; B23K 26/082; B23K 26/21; B23K 101/36; B23K 103/10; B23K 103/12; B23K 103/18; H01M 50/516

(52) U.S. Cl. CPC B23K 26/323; B23K 26/082; B23K 26/21; H01M 50/516; B23K 2101/36; B23K 2103/10; B23K 2103/12; B23K 2103/18

(57) ABSTRACT

In a welding method in which a first metal layer, a second metal layer, and a third metal layer are arranged in this order from an upper side and the first metal layer and the second metal layer are joined by laser welding, the first metal layer and the second metal layer are composed of the same type of first metal material, the third metal layer is composed of a second metal material different from the first metal material, and when joining the first metal layer and the second metal layer by the laser welding by irradiating and scanning with laser light from the first metal layer side, the first metal layer is irradiated with the laser light while turning the laser light from an inner side toward an outer side.

### CROSS REFERENCE TO RELATED APPLICATIONS

This nonprovisional application is based on Japanese Patent Application No. 2024-117467 filed on Jul. 23, 2024 with the Japan Patent Office, the entire contents of which are hereby incorporated by reference.

### BACKGROUND OF THE INVENTION

### Field of the Invention

The present disclosure relates to a welding method and a welding structure.

### Description of the Background Art

WO 2015/129231 discloses a technique relating to a laser welding method of irradiating a lap joint serving as a workpiece with laser light in the form of a spiral. According to the laser welding disclosed in WO 2015/129231, the irradiation with the laser light is performed while moving it along a spiral trajectory such that a liquid phase portion having been melted by the laser light is avoided from being irradiated with the laser light again.

### SUMMARY OF THE INVENTION

Here, in a battery assembly, aluminum may be used for a bus bar, whereas a terminal having a two-layer structure in which an aluminum layer is provided on the outer side and a copper layer is provided on the inner side may be used for an electrode terminal provided in the battery cell. In this case, the bus bar is fixed by laser welding to the aluminum layer of the electrode terminal on the outer side.

In a welding location, an aluminum layer is stacked as a first layer, an aluminum layer is stacked as a second layer, and a copper layer is stacked as a third layer from the outer side. In this case, the first layer and the second layer are composed of the same type of metal material, and the third layer is composed of a different type of metal material from the metal material of each of the first layer and the second layer.

In the case where laser welding is performed in such a stacking structure of metals, it is considered that the welding portion reaches the third layer composed of the different type of metal material at the time of the laser welding between the two upper layers composed of the same type of metal, thereby melting the different type of metal of the third layer. As a result, an intermetallic compound may be generated to result in decreased weld strengths of the two upper layers.

In the conventional laser welding for fixing the bus bar to the electrode terminal, the welding is performed while turning the laser light from the outer side toward the inner side, but the welding tends to be deep in the latter half of the welding. This is due to the following reason: in the latter half of the welding, welding locations are close to each other and are thermally affected with each other to cause deeper welding (molten pool), with the result that the welding portion reaches the different type of metal of the third layer at a deep position, and is melted.

The present disclosure has been made to solve the above-described problem, and has an object to provide a welding method and a welding structure so as to suppress an influence over welding strengths of two upper layers even in the case where welding is performed when a metal different from that of each of the two upper layers is present as a lower layer.
[1] A welding method according to the present disclosure is a welding method in which a first metal layer, a second metal layer, and a third metal layer are arranged in this order from an upper side and the first metal layer and the second metal layer are joined by laser welding, wherein the first metal layer and the second metal layer are composed of the same type of first metal material, the third metal layer is composed of a second metal material different from the first metal material, and when joining the first metal layer and the second metal layer by the laser welding by irradiating and scanning with laser light from the first metal layer side, the first metal layer is irradiated with the laser light while turning the laser light from an inner side toward an outer side.
[2] The welding method according to [1], wherein the scanning with the laser light is performed by irradiating with the laser light while turning the laser light from the inner side toward the outer side along a rectangular shape.
[3] The welding method according to [1] or [2], wherein the first metal material is aluminum, and the second metal material is copper.
[4] The welding method according to any one of [1] to [3], wherein the first metal layer is a bus bar used in a battery assembly, each of the second metal layer and the third metal layer is an electrode terminal of the battery assembly, and the bus bar is welded to the electrode terminal using the laser light.
[5] A welding structure according to the present disclosure is a welding structure in which a first metal layer, a second metal layer, and a third metal layer are arranged in this order from an upper side and the first metal layer and the second metal layer are joined by laser welding, the first metal layer and the second metal layer are composed of the same type of first metal material, the third metal layer is composed of a second metal material different from the first metal material, when joining the first metal layer and the second metal layer by the laser welding by irradiating and scanning with laser light from the first metal layer side, the first metal layer is irradiated with the laser light while turning the laser light from an inner side toward an outer side, and when viewed in a cross section along an irradiation direction of the laser light after the laser welding, a welding depth of a welding portion between the first metal layer and the second metal layer is provided to be shallower on the inner side than a welding depth of the welding portion on the outer side.
[6] The welding structure according to [5], wherein the scanning with the laser light is performed by irradiating with the laser light while turning the laser light from the inner side toward the outer side along a rectangular shape.
[7] The welding structure according to [5] or [6], wherein the first metal material is aluminum, and the second metal material is copper.
[8] The welding structure according to any one of [5] to [7], wherein the first metal layer is a bus bar used in a battery assembly, and each of the second metal layer and the third metal layer is an electrode terminal of the battery assembly.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a basic configuration of a battery assembly.

FIG. 2 is a diagram showing battery cells and end plates in the battery assembly shown in FIG. 1.

FIG. 3 is a diagram showing a battery cell in the battery assembly shown in FIG. 1.

FIG. 4 is a diagram showing an arrangement of bus bars in the battery assembly.

FIG. 5 is a partial cross sectional view in a direction of arrow V in FIG. 4.

FIG. 6 is a schematic view showing a method of welding an electrode terminal and a bus bar.

FIG. 7 is a cross sectional view taken along a line VII-VII in FIG. 6.

FIG. 8 is a cross sectional view in a related art as corresponding to the cross sectional view taken along line VII-VII in FIG. 6.

FIG. 9 is a schematic view showing another method of welding the electrode terminal and the bus bar.

### DESCRIPTION OF THE PREFERRED EMBODIMENTS

Hereinafter, embodiments of the present technology will be described. The same or corresponding portions are denoted by the same reference characters, and may not be described repeatedly.

In the embodiments described below, when reference is made to number, amount, and the like, the scope of the present technology is not necessarily limited to the number, amount, and the like unless otherwise stated particularly. In the embodiments described below, each component is not necessarily essential to the present technology unless otherwise stated particularly. The present technology is not limited to one that necessarily exhibits all the functions and effects stated in the present embodiment.

In the present specification, the terms “comprise”, “include”, and “have” are open-end terms. That is, when a certain configuration is included, a configuration other than the foregoing configuration may or may not be included.

In the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

A battery assembly 1 described below can be mounted on a battery electric vehicle (BEV), a plug-in hybrid electric vehicle (PHEV), a hybrid electric vehicle (HEV), or the like. It should be noted that the purpose of use of battery assembly 1 is not limited to the use on a vehicle.

### (Battery Assembly 1)

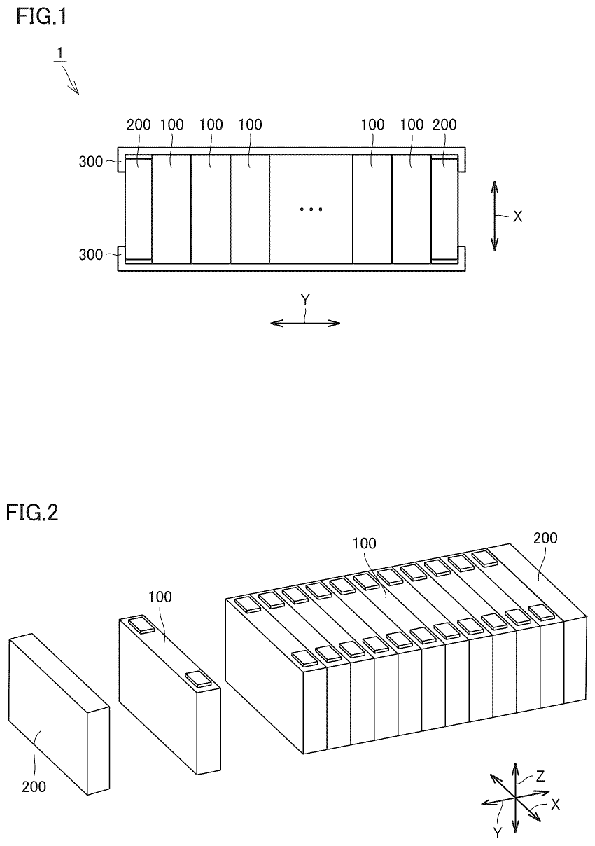

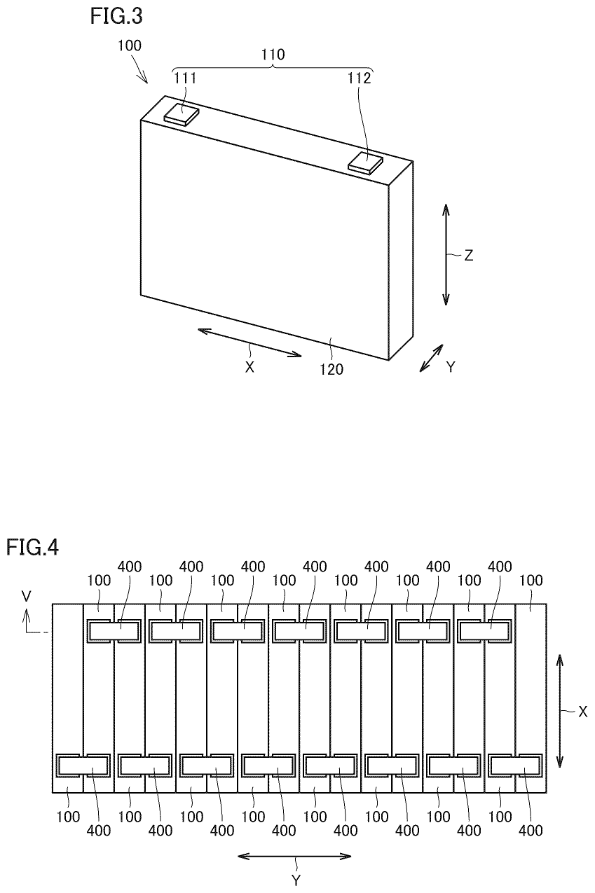

FIG. 1 is a diagram showing a basic configuration of battery assembly 1. FIG. 2 is a diagram showing battery cells 100 and end plates 200 included in battery assembly 1. FIG. 3 is a diagram showing battery cell 100 in battery assembly 1.

As shown in FIGS. 1 and 2, battery assembly 1, which serves as an exemplary “power storage module”, includes battery cells 100, end plates 200, and a restraint member 300.

As one example, battery cell 100 is a lithium ion battery but may be another battery such as a nickel-metal hydride battery.

The plurality of battery cells 100 are provided side by side in a Y axis direction (arrangement direction). Each of battery cells 100 includes electrode terminals 110. A separator (not shown) may be interposed between the plurality of battery cells 100. The plurality of battery cells 100, which are sandwiched between two end plates 200, are pressed by end plates 200, and are therefore restrained between two end plates 200.

End plates 200 are disposed at both ends of battery assembly 1 in the Y axis direction (arrangement direction). Each of end plates 200 is fixed to a base such as a case that accommodates battery assembly 1.

Restraint member 300 connects two end plates 200 to each other. Restraint member 300 is attached to two end plates 200.

Restraint member 300 is engaged with end plates 200 with compression force in the Y axis direction being exerted to the stack of the plurality of battery cells 100 and end plates 200, and then the compression force is released, with the result that tensile force acts on restraint member 300 that connects two end plates 200 to each other. As a reaction thereto, restraint member 300 presses two end plates 200 in directions of bringing them closer to each other.

As shown in FIG. 3, battery cell 100 is formed to have a rectangular parallelepiped shape with a flat surface. Electrode terminals 110 include a positive electrode terminal 111 and a negative electrode terminal 112. Electrode terminals 110 are formed on the upper surface of a housing 120 having a prismatic shape. An electrode assembly (not shown) and an electrolyte solution (not shown) are accommodated in housing 120. For convenience of description of an implementation of each battery cell 100, the X direction may be referred to as a width direction, the Y direction may be referred to as a thickness direction, and the Z direction may be referred to as a height direction in the description below.

FIG. 4 is a diagram showing an arrangement of bus bars 400 in battery assembly 1. In the example of FIG. 4, positive electrode terminal 111 and negative electrode terminal 112 of adjacent battery cells 100 are electrically connected together by bus bar 400, with the result that the plurality of battery cells 100 are electrically connected together in series.

That is, battery assembly 1 includes: the plurality of battery cells 100 each having electrode terminals 110 and arranged along a predetermined direction; and bus bars 400 that connect electrode terminals 110 of the plurality of battery cells 100.

### (Welding Method and Welding Structure)

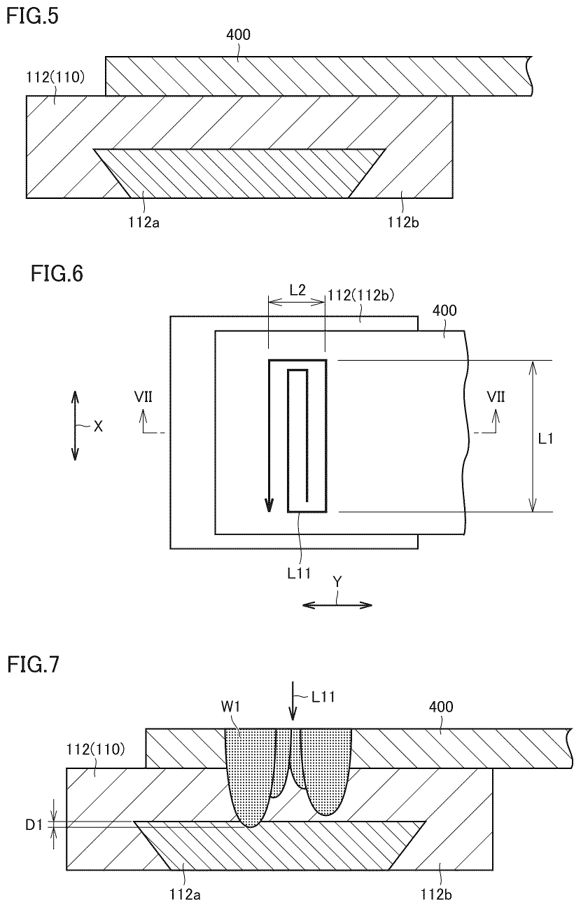

Next, a welding method for welding electrode terminal 110 and bus bar 400 and a welding structure between electrode terminal 110 and bus bar 400 will be described with reference to FIGS. 5 and 6. As one example, the following describes a case where negative electrode terminal 112 serving as electrode terminal 110 and bus bar 400 are welded.

Bus bar 400 (first metal layer) is composed of aluminum. Negative electrode terminal 112 has: a first electrode member 112a connected to a battery element (not shown) provided inside battery cell 100; and a second electrode member 112b provided to cover first electrode member 112a and to be integrated with first electrode member 112a. Second electrode member 112b is composed of an aluminum material (second metal layer) because bus bar 400 is fixed to second electrode member 112b by welding. First electrode member 112a is composed of copper (third metal layer) in order to improve electrical connection with the battery element (not shown) provided inside battery cell 100.

Bus bar 400 and negative electrode terminal 112 are joined together in the following manner: the first metal layer, the second metal layer, and the third metal layer are arranged in this order from the upper side, and the first metal layer and the second metal layer are joined by laser welding. The first metal layer and the second metal layer are composed of the same type of first metal material (aluminum), and the third metal layer is composed of a second metal material (copper) different from the first metal material.

As shown in FIG. 6, bus bar 400 and second electrode member 112b are fixed by welding using laser light (L11). In the present embodiment, when joining bus bar 400 and second electrode member 112b by laser welding by irradiating with the laser light (L11) from the bus bar 400 side, bus bar 400 is scanned with the laser light (L11) while turning the laser light (L11) from the inner side toward the outer side.

In the present embodiment, the scanning with the laser light (L11) is performed by irradiating with the laser light (L11) while turning the laser light (L11) from the inner side toward the outer side along a rectangular shape. As the rectangular shape, it is preferable to employ a rectangular shape having a long side corresponding to the width direction (X direction) of battery cell 100 and a short side corresponding to the thickness direction (Y direction).

As one example, when the thickness of bus bar 400 is about 0.8 mm, the thickness of first electrode member 112a is about 0.7 mm, and the thickness of the welding portion of second electrode member 112b is about 0.7 mm, the output of the laser light (L11) is 1500 W, the scanning rate is 400 mm/s, the long side (L1) of the rectangular shape after the irradiation with the laser light (L11) is about 5 mm, and the short side (L2) thereof is about 1 mm, for example.

As viewed in a cross section of the welding portion along an irradiation direction of the laser light after the laser welding as shown in FIG. 7, when the above-described welding method is used, bus bar 400 is scanned with the laser light (L11) while turning the laser light (L11) from the inner side toward the outer side, and the welding depth of a molten pool (W1) is therefore deeper on the outer side than that on the inner side; however, welding locations by the laser light (L11) are welded at longer time intervals as the laser light (L11) is moved toward the outer side, with the result that the welding locations are less likely to be thermally affected. Furthermore, heat can be radiated to the outer side, thereby suppressing the thermal effect therebetween to the minimum.

As a result, even when the welding depth of the molten pool (W1) reaches second electrode member 112b serving as the third metal layer on the outer side, the depth (D1) is suppressed to a minimum depth, and an intermetallic compound can also be suppressed from being generated.

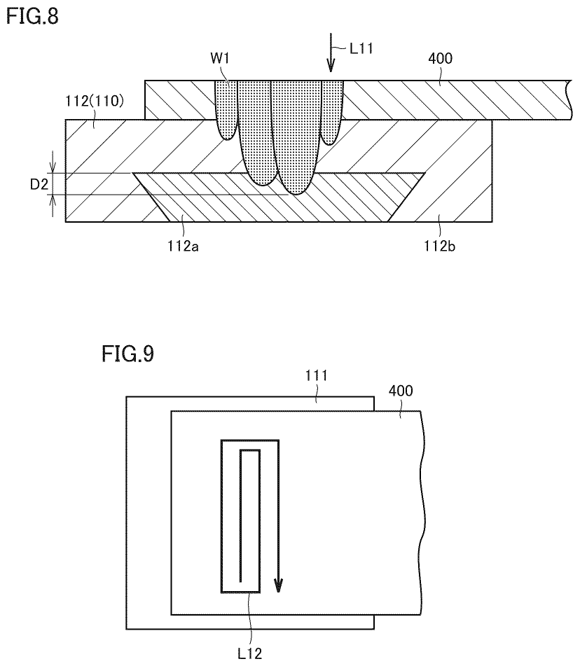

On the other hand, a cross sectional structure of a welding portion in FIG. 8 represents that in the case where bus bar 400 is scanned with the laser light (L11) while turning the laser light (L11) from the outer side toward the inner side under the same conditions as above. In this case, welding locations by the laser light (L11) are welded at shorter time intervals as the laser light (L11) is moved toward the inner side, and are thermally affected greatly. Moreover, heat is less likely to be radiated to the outer side and the heat is accumulated on the inner side, thus resulting in a high temperature state on the inner side.

As a result, on the inner side (central portion), the depth (D2) of the molten pool (W1) becomes deep and the third metal layer reaches second electrode member 112b at a deep position, thereby promoting generation of the intermetallic compound.

It should be noted that it has been illustratively described that the irradiation with the laser light (L11) is performed in a counterclockwise turning direction as shown in FIG. 6; however, the irradiation of the laser light (L11) may be performed in a clockwise turning direction as shown in FIG. 9.

It should be noted that in the above description, it has been described that bus bar 400 is welded to electrode terminal 110 provided in battery cell 100; however, it is not limited to being applied to this exemplary case, and can be applied to a connection location having a similar configuration.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A welding method in which a first metal layer, a second metal layer, and a third metal layer are arranged in this order from an upper side and the first metal layer and the second metal layer are joined by laser welding, wherein
the first metal layer and the second metal layer are composed of the same type of first metal material,
the third metal layer is composed of a second metal material different from the first metal material, and
when joining the first metal layer and the second metal layer by the laser welding by irradiating and scanning with laser light from the first metal layer side, the first metal layer is irradiated with the laser light while turning the laser light from an inner side toward an outer side.

2. The welding method according to claim 1, wherein the scanning with the laser light is performed by irradiating with the laser light while turning the laser light from the inner side toward the outer side along a rectangular shape.

3. The welding method according to claim 1, wherein
the first metal material is aluminum, and
the second metal material is copper.

4. The welding method according to claim 1, wherein
the first metal layer is a bus bar used in a battery assembly,
each of the second metal layer and the third metal layer is an electrode terminal of the battery assembly, and
the bus bar is welded to the electrode terminal using the laser light.

5. A welding structure in which a first metal layer, a second metal layer, and a third metal layer are arranged in this order from an upper side and the first metal layer and the second metal layer are joined by laser welding,
the first metal layer and the second metal layer are composed of the same type of first metal material,
the third metal layer is composed of a second metal material different from the first metal material,
when joining the first metal layer and the second metal layer by the laser welding by irradiating and scanning with laser light from the first metal layer side, the first metal layer is irradiated with the laser light while turning the laser light from an inner side toward an outer side, and
when viewed in a cross section along an irradiation direction of the laser light after the laser welding, a welding depth of a welding portion between the first metal layer and the second metal layer is provided to be shallower on the inner side than a welding depth of the welding portion on the outer side.

6. The welding structure according to claim 5, wherein the scanning with the laser light is performed by irradiating with the laser light while turning the laser light from the inner side toward the outer side along a rectangular shape.

7. The welding structure according to claim 5, wherein
the first metal material is aluminum, and
the second metal material is copper.

8. The welding structure according to claim 5, wherein
the first metal layer is a bus bar used in a battery assembly, and
each of the second metal layer and the third metal layer is an electrode terminal of the battery assembly.
